(19) United States
(12) Patent Application Publication
(10) Pub. No.: US 2017/0257692 A1
(43) Pub. Date: Sep. 7, 2017

(54) Low-loss wireless stereo Bluetooth earphones

(71) Applicant: Charter Media (Dongguan) Co., Ltd., Dongguan, Guangdong (CN)

(72) Inventors: Shaocong Yang, Dongguan (CN); Man Lung Lam, Dongguan (CN)

(21) Appl. No.: 14/786,548

(22) PCT Filed: Apr. 1, 2015
(86) PCT No.: PCT/CN2015/000227

§ 371 Date: Oct. 23, 2015

(30) Foreign Application Priority Data
Oct. 30, 2014 (CN) 201410597710.7

(51) Int. Cl. H04R 1/10; H04W 4/00

(52) U.S. Cl. CPC H04R 1/1041; H04R 1/1016; H04R 1/1058; H04W 4/008; H04R 2420/07

(57) ABSTRACT

Low-loss wireless stereo Bluetooth earphones, which relate to a technical field of communication, include: a left Bluetooth earphone and a right Bluetooth earphone; both the left Bluetooth earphone and the right Bluetooth earphone comprise an earphone shell; a master control PCB with a chip, and a speaker unit are mounted inside the earphone shell, a Bluetooth RF transceiver module, a power module and an antenna module are installed on the master control PCB, and the antenna module is connected to the master control PCB through an RF coaxial wire; a speaker is mounted at a front portion of the earphone shell; a hanger is provided at a middle portion of the earphone shell; and an antenna is mounted at a rear portion of the earphone shell; during wearing, the antenna extends backwards and is behind an auricle. During wearing, the antenna extends outwards to the back of the ear, which is not limited by the structure of the ear. A distance between the antennas of the left Bluetooth earphone and the right Bluetooth earphone is decreased, as well as a barrier caused by the head. According to measurement results, the RF path loss is 60 dB, which is improved by about 20 dB, thereby providing stable audio transmission to the Bluetooth earphones.

### CROSS REFERENCE OF RELATED APPLICATION

This is a U.S. National Stage under 35 U.S.C 371 of the International Application PCT/CN2015/000227, filed Apr. 1, 2015, which claims priority under 35 U.S.C. 119(a-d) to CN 201410597710.7, filed Oct. 30, 2014.

### BACKGROUND OF THE PRESENT INVENTION

Field of Invention

The present invention relates to a technical field of communication, particularly to a wireless earphone, and more particularly to a low-loss wireless stereo Bluetooth earphone.

Description of Related Arts

Bluetooth audio receiver has been listed for many years. All receivers have integrated circuits with a single system chip, in order to communicate with a Bluetooth transmitter or an independent audio transmitter from a smart phone or PC.

Referring to FIG. 1, the Bluetooth earphone with a physical wire is provided, comprising a Bluetooth receiver B101, a left speaker B102 and a right speaker B103. This type of stereo headphones transmit signals through a physical wire B104, the Bluetooth receiver respectively transmits audio signals to the left speaker and the right speaker. For stereo headphones, left and right audios of a stereo audio received by the Bluetooth receiver are amplified, and are transmitted to drivers of the left and right speakers through the physical wire.

With the development of wireless communication technology, after stereo audio signals are received, left or right audio single is able to be wirelessly re-transmitted another chip, so as to displace the wire between the left and right speakers. The transmission technology is known as “the real wireless stereo”. The system uses two Bluetooth chip sets, one as a master chipset and the other as a slave chipset. The master chipset supports call handling and control, and then forwards an audio stream to the slave chipset, which makes the product compatible with any conventional A2DP device on the market. The audio is transmitted to the master chipset from the audio source, and is transmitted to the slave chipset according to a patented synchronization protocol, in such a manner that a real wireless stereo is formed for being transmitted to an earphone or a speaker. In general, a distance between the speakers is able to exceed 10 m, which is enough to meet the needs of ordinary users.

Referring to FIG. 2 and FIG. 4, wireless stereo Bluetooth earphones are provided, comprising a left in-ear Bluetooth earphone B201 and a right in-ear Bluetooth earphone B202. Usually an antenna is placed inside a small-size shell of the earphone and the earphone is placed at an auditory meatus of an ear B203. The antenna is integrated in a main control circuit board. Because of a structure of the ear, a lot of defects will occur in practice, which brings a lot of technical problems to designers. When a system chip in a right earphone transmits a left audio signal to the other system chip in a left earphone, head will be a physical barrier, resulting in extremely high loss at 2.4 GHz through the head. Referring to FIG. 3, there is about 80 dB RF path loss according to a test. When insufficient safety margin and receiving link budget are provided to coupling of left and right antennas, audio transmission is unstable.

### SUMMARY OF THE PRESENT INVENTION

An object of the present invention is to overcome the above defects and provide low-loss wireless stereo Bluetooth earphones.

Accordingly, in order to accomplish the above object, a possible method is increasing a transmitter power of a system chip. However, the method requires using a large battery in a larger earphone, which is not wanted by users. Another method is lowering RF path loss, wherein by designing an efficient transmitting/receiving antenna system, the RF path loss is able to be lowered.

The RF path loss depends on a working frequency, a distance between a transmitter and a receiver, and a physical barrier therebetween. For a wireless stereo Bluetooth earphone, the working frequency is limited at 2.45 GHz by standards, which is not able to be improved. Multi-path reflection leads to frequent change of a practical environment of RF receiving, standing waves and sizes of user heads may also be very important. Therefore, emphasis of design may be put on a working distance and the physical barrier.

The present invention provides:

low-loss wireless stereo Bluetooth earphones, comprising: a left Bluetooth earphone and a right Bluetooth earphone, wherein the left Bluetooth earphone wirelessly communicates with the right Bluetooth earphone through Bluetooth;

wherein both the left Bluetooth earphone and the right Bluetooth earphone comprise an earphone shell; a master control PCB (printed circuit board) with a chip, and a speaker unit are mounted inside the earphone shell, the speaker unit is connected to the master control PCB; wherein: a Bluetooth RF (radio frequency) transceiver module, a power module and an antenna module are installed on the master control PCB, and the antenna module is connected to the master control PCB through an RF coaxial wire;

wherein the master control PCB and a speaker of the speaker unit are mounted at a front portion of the earphone shell; during wearing, the speaker presses against an auditory meatus of an ear, wherein a structure of the speaker is the same as a structure of the speaker of conventional earphones; a hanger is provided at a middle portion of the earphone shell for assisting hanging on the ear; during wearing, the hanger is placed at a back of the ear, wherein according to the present invention, some functions of the hanger are the same as that of conventional earphones with hangers, which assists wearing as well as extending an antenna, in such a manner that the antenna extends to a place which is not affected by the head and the ears; the antenna of the antenna module is mounted at a rear portion of the earphone shell; a first end of the RF coaxial wire is connected to the master control PCB, a second end thereof passes through the hanger and extends to the antenna, for being connected to the antenna module; during wearing, the antenna extends backwards and is behind an auricle, thereby correctly reaching a max gain and efficiency, which means that the distance between antennas are reduced and a block effect of the to head is lowered.

Preferably, the antenna module comprises a left antenna module mounted in the left Bluetooth earphone, and a right antenna module mounted in the right Bluetooth earphone. The left antenna module may be the same as the right antenna module or not, which depends on a practical performance level needed.

Preferably, the left antenna module comprises a reversed F-shaped antenna, a ceramic antenna, a coil antenna, a micro-strip antenna, a metal strip antenna or a diversity antenna. As long as the max gain and efficiency are correctly reached, different antennas may be used.

Preferably, the right antenna module comprises a reversed F-shaped antenna, a ceramic antenna, a coil antenna, a micro-strip antenna, a metal strip antenna or a diversity antenna. As long as the max gain and efficiency are correctly reached, different antennas may be used.

Preferably, the earphone shell is made of a soft plastic material or a hard plastic material. A specific shape of the earphone shell may be designed according to market requirements. As long as the antenna module extends to the back of the ear, a loss problem is able to be solved. The specific shape of the earphone shell may be optimized according to wearing comfort.

Preferably, the speaker, the hanger and the antenna are integrated with each other.

Preferably, the hanger has an arc structure; a length of the antenna is no less than a length of the hanger. According to experiments, the longer the antenna is, the lower the loss will be.

Preferably, a plurality of functional buttons are provided at an external surface of the earphone shell, comprising a power switch button, and a volume control button.

Preferably, a charging interface is connected to and installed on the master control PCB.

Preferably, the Bluetooth RF transceiver module comprises a left Bluetooth transceiver mounted in the left Bluetooth earphone, and a right Bluetooth transceiver mounted in the right Bluetooth earphone. Right audio signals are audio signals which are directly received from different electronic devices. Left audio signals are transmitted from the right Bluetooth transceiver to the left Bluetooth transceiver through a low RF path loss medium, or the right audio signals are transmitted from the left Bluetooth transceiver to the right Bluetooth transceiver through the low RF path loss medium.

Advantages of the present invention are as follows: the hanger and the antenna are designed on the earphone shell, in such a manner that during wearing, the antenna extends outwards to the back of the ear, which is not limited by the structure of the ear. With such design, the distance between the antennas of the left Bluetooth earphone and the right Bluetooth earphone is decreased, as well as barrier caused by the head. According to measurement results, the RF path loss is 60 dB, which is improved by about 20 dB, thereby providing stable audio transmission to the Bluetooth earphones and ensuring security of the audio transmission.

### BRIEF DESCRIPTION OF THE DRAWINGS

FIG. 1 is a perspective view of a first prior art.

FIG. 2 is a perspective view of a second prior art.

FIG. 3 is a loss curve of earphones in FIG. 2.

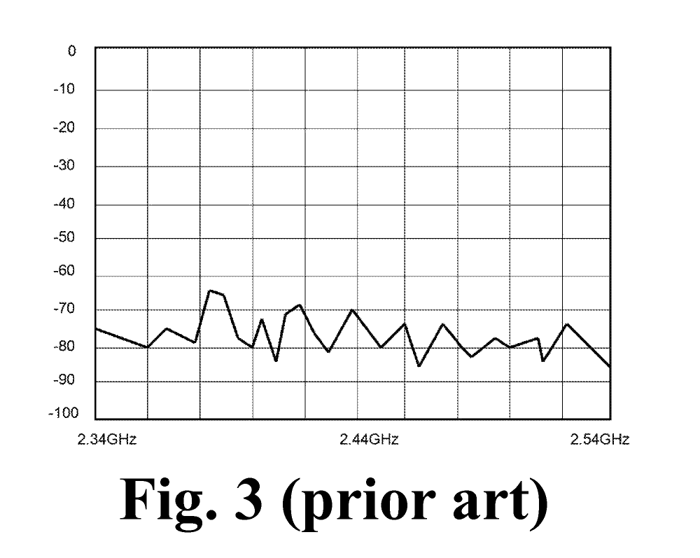

FIG. 4 illustrates a wearing state of the earphones in FIG. 2.

FIG. 5 is a sketch view of an internal structure according to a preferred embodiment of the present invention.

FIG. 6 is a loss curve of earphones in FIG. 5.

FIG. 7 illustrates a wearing state of the earphone according to the preferred embodiment of the present invention.

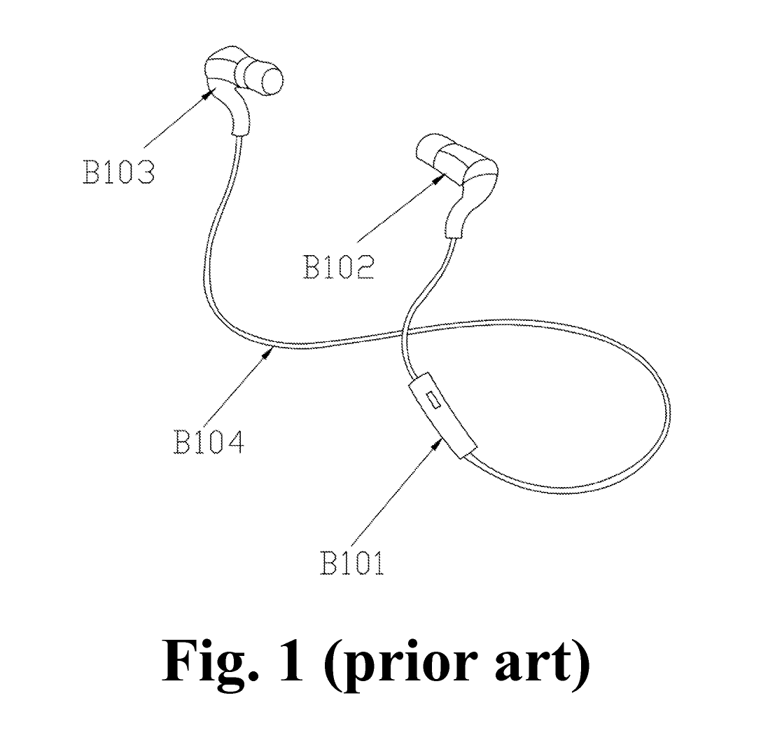

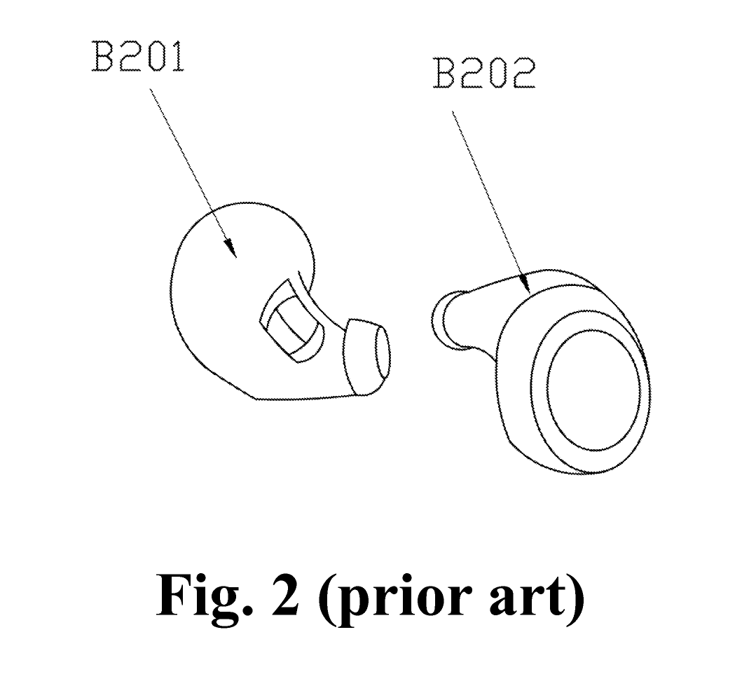

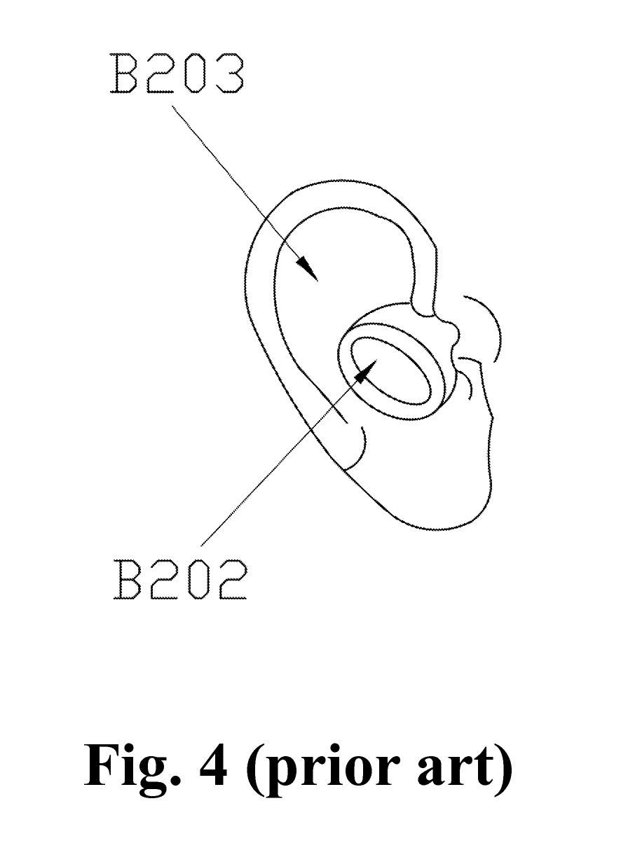

Element reference in FIGS. 1, 2 and 4: Bluetooth receiver B101, left speaker B102, right speaker B103, physical wire B104, left in-ear Bluetooth earphone B201, right in-ear Bluetooth earphone B202, ear B203.

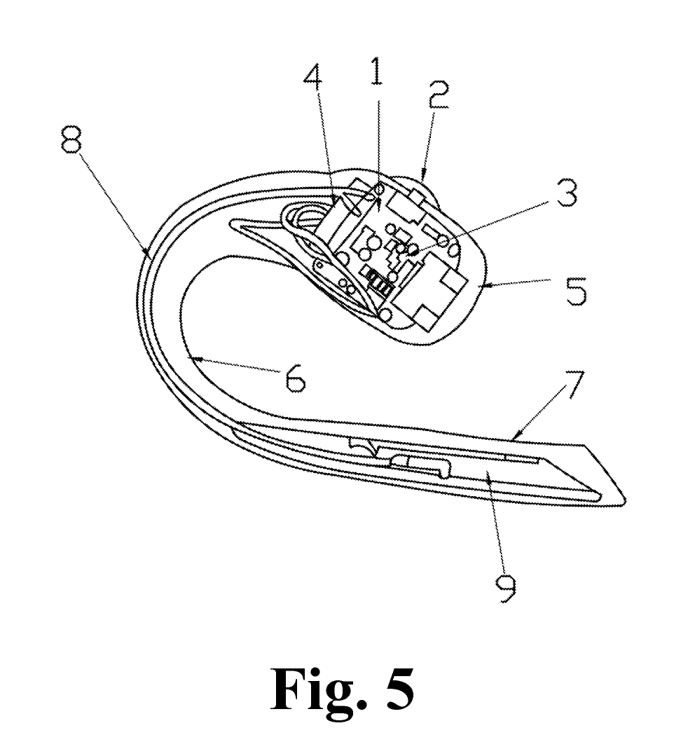

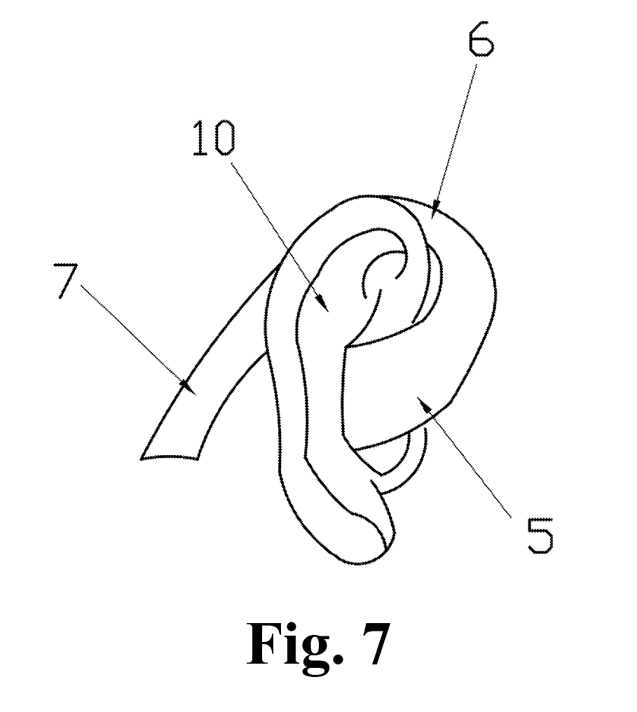

Element reference in FIGS. 5 and 7: master control PCB 1, speaker unit 2, right Bluetooth transceiver 3, power module 4, speaker 5, hanger 6, antenna 7, RF coaxial wire 8, reversed F-shaped antenna 9, ear 10.

### DETAILED DESCRIPTION OF THE PREFERRED EMBODIMENT

The present invention is further illustrated in detail combined with the drawings and the preferred embodiment.

In the preferred embodiment, referring to FIG. 5, low-loss wireless stereo Bluetooth earphones are provided, comprising: a left Bluetooth earphone and a right Bluetooth earphone, wherein the left Bluetooth earphone wirelessly communicates with the right Bluetooth earphone through Bluetooth. Both the left Bluetooth earphone and the right Bluetooth earphone comprise an earphone shell. Because a structure of the left Bluetooth earphone is a mirror image of a structure of the right Bluetooth earphone, only the right Bluetooth earphone is illustrated in the FIG. 5.

A master control PCB (printed circuit board) 1 with a chip, and a speaker unit 2 are mounted inside the earphone shell, the speaker unit 2 is connected to the master control PCB 1. A Bluetooth RF (radio frequency) transceiver module, a power module 4 and an antenna module are installed on the master control PCB 1, and the antenna module is connected to the master control PCB 1 through an RF coaxial wire 8. The Bluetooth RF transceiver module comprises a left Bluetooth transceiver mounted in the left Bluetooth earphone, and a right Bluetooth transceiver 3 mounted in the right Bluetooth earphone. The antenna module comprises a left antenna module mounted in the left Bluetooth earphone, and a right antenna module mounted in the right Bluetooth earphone. According to the preferred embodiment, the power module 4 is a rechargeable lithium battery, which is connected to the master control PCB 1. A charging interface is connected to and installed on the master control PCB 1.

Referring to FIG. 5, the master control PCB 1 and a speaker 5 of the speaker unit 2 are mounted at a front portion of the earphone shell; during wearing, the speaker 5 presses against an auditory meatus of an ear 10, wherein a structure of the speaker 5 is the same as a structure of the speaker of conventional earphones. A hanger 6 is provided at a middle portion of the earphone shell for assisting hanging on the ear; during wearing, the hanger 6 is placed at a back of the ear, wherein according to the preferred embodiment, some functions of the hanger 6 are the same as that of conventional earphones with hangers, which assists wearing as well as extending an antenna, in such a manner that the antenna extends to a place which is not affected by the head and the ears 10; the antenna 7 of the antenna module is mounted at a rear portion of the earphone shell; a first end of the RF coaxial wire 8 is connected to the master control PCB 1, a second end thereof passes through the hanger 6 and extends to the antenna 7, for being connected to the antenna module; during wearing, the antenna 7 extends backwards and is behind an auricle, thereby correctly reaching a max gain and efficiency, which means that the distance between antennas are reduced and a block effect of the head is lowered.

In addition, for conveniently installing the master control PCB 1 and the speaker unit 2, the earphone shell according to the preferred embodiment comprises an upper shell and a lower shell matching each other. The speaker 5, the hanger 6 and the antenna 7 are integrated with each other. The hanger 6 has an arc structure. The antenna 7 extends along an end of the hanger 6, for ensuring a sufficient length of the antenna module mounted inside, in such a manner that a distance between the antennas of the left Bluetooth earphone and the right Bluetooth earphone is decreased, as well as a barrier caused by the head. For increasing comfort during wearing, the earphone shell is made of a soft plastic material such as silica gel.

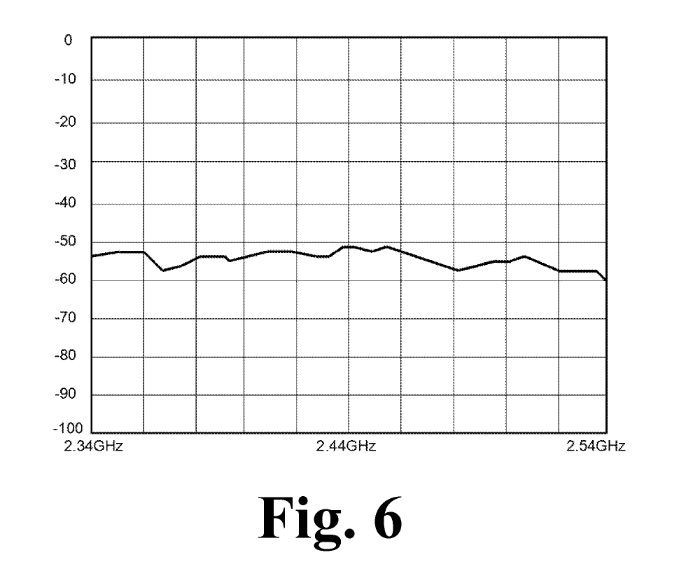

Referring to FIGS. 6 and 7, during wearing, the antenna 7 extends outwards to the back of the ear, which is not limited by the structure of the ear 10. For testing performance of the present invention, the left and right antenna modules are all formed by reversed F-shaped antennas 9. The test was provided in offices, homes, cars, outdoor parks, ferry terminals, etc. According to results, audio transmission is stable and secure. When the antenna 7 is designed at the back of the ear 10, an insertion loss is no more than 60 dB according to the test results. Compared with the conventional in-ear earphones, the insertion loss is improved by 20 dB, which provides stable audio transmission to the Bluetooth earphones, and greatly improves audio quality of the wireless stereo Bluetooth earphones.

It will thus be seen that the objects of the present invention have been fully and effectively accomplished. Its embodiments have been shown and described for the purposes of illustrating the functional and structural principles of the present invention and is subject to change without departure from such principles. Therefore, this invention includes all modifications encompassed within the spirit and scope of the following claims.

1-10. (canceled)

11. Low-loss wireless stereo Bluetooth earphones, comprising: a left Bluetooth earphone and a right Bluetooth earphone, wherein the left Bluetooth earphone wirelessly communicates with the right Bluetooth earphone through Bluetooth; both the left Bluetooth earphone and the right Bluetooth earphone comprise an earphone shell; a master control PCB (printed circuit board) with a chip, and a speaker unit are mounted inside the earphone shell, the speaker unit is connected to the master control PCB; wherein: a Bluetooth RF (radio frequency) transceiver module, a power module and an antenna module are installed on the master control PCB, and the antenna module is connected to the master control PCB through an RF coaxial wire; the master control PCB and a speaker of the speaker unit are mounted at a front portion of the earphone shell; during wearing, the speaker presses against an auditory meatus of an ear; a hanger is provided at a middle portion of the earphone shell for assisting hanging on the ear; during wearing, the hanger is placed at a back of the ear; an antenna of the antenna module is mounted at a rear portion of the earphone shell; a first end of the RF coaxial wire is connected to the master control PCB, a second end thereof passes through the hanger and extends to the antenna, for being connected to the antenna module; during wearing, the antenna extends backwards and is behind an auricle.

12. The low-loss wireless stereo Bluetooth earphones, as recited in claim 11, wherein the antenna module comprises a left antenna module mounted in the left Bluetooth earphone, and a right antenna module mounted in the right Bluetooth earphone.

13. The low-loss wireless stereo Bluetooth earphones, as recited in claim 12, wherein the left antenna module comprises a reversed F-shaped antenna, a ceramic antenna, a coil antenna, a micro-strip antenna, a metal strip antenna or a diversity antenna.

14. The low-loss wireless stereo Bluetooth earphones, as recited in claim 12, wherein the right antenna module comprises a reversed F-shaped antenna, a ceramic antenna, a coil antenna, a micro-strip antenna, a metal strip antenna or a diversity antenna.

15. The low-loss wireless stereo Bluetooth earphones, as recited in claim 11, wherein the earphone shell is made of a soft plastic material or a hard plastic material.

16. The low-loss wireless stereo Bluetooth earphones, as recited in claim 13, wherein the earphone shell is made of a soft plastic material or a hard plastic material.

17. The low-loss wireless stereo Bluetooth earphones, as recited in claim 14, wherein the earphone shell is made of a soft plastic material or a hard plastic material.

18. The low-loss wireless stereo Bluetooth earphones, as recited in claim 15, wherein the speaker, the hanger and the antenna are integrated with each other.

19. The low-loss wireless stereo Bluetooth earphones, as recited in claim 16, wherein the speaker, the hanger and the antenna are integrated with each other.

20. The low-loss wireless stereo Bluetooth earphones, as recited in claim 17, wherein the speaker, the hanger and the antenna are integrated with each other.

21. The low-loss wireless stereo Bluetooth earphones, as recited in claim 18, wherein the hanger has an arc structure; a length of the antenna is no less than a length of the hanger.

22. The low-loss wireless stereo Bluetooth earphones, as recited in claim 19, wherein the hanger has an arc structure; a length of the antenna is no less than a length of the hanger.

23. The low-loss wireless stereo Bluetooth earphones, as recited in claim 20, wherein the hanger has an arc structure; a length of the antenna is no less than a length of the hanger.

24. The low-loss wireless stereo Bluetooth earphones, as recited in claim 11, wherein a plurality of functional buttons are provided at an external surface of the earphone shell, comprising a power switch button, and a volume control button.

25. The low-loss wireless stereo Bluetooth earphones, as recited in claim 23, wherein a plurality of functional buttons are provided at an external surface of the earphone shell, comprising a power switch button, and a volume control button.

26. The low-loss wireless stereo Bluetooth earphones, as recited in claim 11, wherein a charging interface is connected to and installed on the master control PCB.

27. The low-loss wireless stereo Bluetooth earphones, as recited in claim 24, wherein a charging interface is connected to and installed on the master control PCB.

28. The low-loss wireless stereo Bluetooth earphones, as recited in claim 11, wherein the Bluetooth RF transceiver module comprises a left Bluetooth transceiver mounted in the left Bluetooth earphone, and a right Bluetooth transceiver mounted in the right Bluetooth earphone.

29. The low-loss wireless stereo Bluetooth earphones, as recited in claim 20, wherein the Bluetooth RF transceiver module comprises a left Bluetooth transceiver mounted in the left Bluetooth earphone, and a right Bluetooth transceiver mounted in the right Bluetooth earphone.

30. The low-loss wireless stereo Bluetooth earphones, as recited in claim 23, wherein the Bluetooth RF transceiver module comprises a left Bluetooth transceiver mounted in the left Bluetooth earphone, and a right Bluetooth transceiver mounted in the right Bluetooth earphone.
